(19) United States
(12) Patent Application Publication
(10) Pub. No.: US 2009/0001787 A1
(43) Pub. Date: Jan. 1, 2009

(54) Ionized Air System and Method for Dissipating an Electrostatic Charge in a Vehicle

(75) Inventors: Jennifer P. Lawall, Waterford, MI (US); Diane K. Mc Queen, Leonard, MI (US); Steven E. Morris, Fair Haven, MI (US); David J. Trzcinski, Howell, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/768,443

(22) Filed: Jun. 26, 2007

(51) Int. Cl. H05F 3/00; A47C 7/74

(52) U.S. Cl. 297/217.1; 361/213

(57) ABSTRACT

An apparatus is provided for dissipating an electrostatic charge from a vehicle seat and from an occupant seated thereon, wherein a blower directs ionized air through a vent toward the seat and occupant to neutralize an electrostatic charge accumulated on the surface and occupant. A sensor is configured to detect when the occupant is separating from the vehicle seat, and to activate the ionizer in response thereto. The apparatus also includes a seat cooling system for directing cool air through the seat, wherein a blower directs ionized air through vent holes in the seat when the cooling system is operating. A method is also provided for dissipating an electrostatic charge from a vehicle seat and an occupant seated thereon, including generating ionized air, sensing separation of a passenger from the seat, and directing ionized air toward the seat and occupant through one or more vents to dissipate the static charge.

### TECHNICAL FIELD

This invention relates to a system and method for neutralizing or dissipating an electrostatic charge from a surface of a vehicle seat and an occupant of the seat using a sufficient amount of ionized air to thereby minimize an electrostatic discharge between an exiting occupant and the vehicle.

### BACKGROUND OF THE INVENTION

Electrostatic discharge (ESD) is the rapid transfer of an accumulated electrostatic charge resulting from proximate or direct contact between two bodies or objects having different electric potentials. The severity of an ESD event may be influenced or affected by a number of environmental and/or physical factors, including the composition of various materials of construction, relative motion of the two bodies, low atmospheric humidity, and/or improper or inadequate grounding. Negative and positive charges are created on the surfaces of the two bodies when the bodies are separated. These charges are then effectively neutralized as the charges seek a grounding path. Thus, ESD occurs when a charged body or object comes in proximity to a conductive material offering an efficient path to ground. Various ESD control devices therefore exist for the purpose of reducing the potential for static build-up and/or to provide an alternate grounding path for harmlessly dissipating any built-up electrostatic charge, or for discharging an electrostatic charge well before a substantial amount of charge may build. Such devices may include grounding straps, ESD-prevention smocks or other anti-ESD clothing, and humidifiers.

As it relates to automotive vehicles, an ESD event is most commonly experienced as an instantaneous discharge that results when a vehicle passenger or occupant touches a door handle or other metal component upon exiting the vehicle. Various devices exist for controlling the effects of ESD in automotive vehicles, with varying effectiveness. For example, conductive tires or grounding straps attached to the underside of the vehicle frame may be used to dissipate a static charge from the vehicle. However, these devices may be less than optimal due to wear of the device, such as may occur when dragging a grounding strap on the pavement, as well as added cost, inconvenience, and/or unattractive appearance of such devices. Additionally, such grounding devices may be relatively ineffective in grounding an occupant due to the inability of the seat surface, i.e. the interface between the seat and the occupant, to provide an efficient conductive path to the grounding devices.

### SUMMARY OF THE INVENTION

Accordingly, an apparatus is provided for dissipating an electrostatic charge from a surface of a vehicle seat and an occupant seated on the surface. The apparatus includes an ionizer for ionizing a supply of air and a blower for directing the ionized air toward the surface to neutralize or dissipate an accumulated electrostatic charge on the occupant and surface.

In one aspect of the invention, the blower directs the ionized air toward the surface through a vent positioned external to the seat, such as a heating, ventilation, and air conditioning (HVAC) blower vent positioned on a door, console, or instrument panel.

In another aspect of the invention, a sensor is configured to detect when the occupant is separating from the vehicle seat, with the blower directing the ionized air at the surface when separation is detected by the sensor.

In another aspect of the invention, the apparatus includes a seat cooling system having a perforated vent positioned within the vehicle seat, with the blower directing the ionized air at the seat surface through the perforated vent.

In another aspect of the invention, the perforated vent is sufficiently positioned to function as the seating surface.

In another aspect of the invention, a method is provided for dissipating an electrostatic charge from a vehicle occupant and a vehicle seat, including generating a supply of ionized air, sensing separation of the occupant from the surface, and directing ionized air at the surface to dissipate the electrostatic charge.

In another aspect of the invention, the method includes passing ionized air through a vent positioned external to the vehicle seat.

In another aspect of the invention, the method includes equipping the vehicle seat with a seat cooling system having a vent for directing a supply of cool air through the seat to cool the occupant, the ionized air being an ionized portion of the cool air.

The above objects, features and advantages, and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a fragmentary schematic cutaway side view of a vehicle having a static-reducing ionizing blower system according to the invention;

FIG. 2 is a fragmentary perspective side view of a portion of a passenger compartment of a vehicle having the static-reducing ionizing blower system of FIG. 1; and

FIG. 3 is a perspective side view of a vehicle seat in phantom to show a cooling system and ionizing blower according to the invention.

### DESCRIPTION OF THE PREFERRED EMBODIMENTS

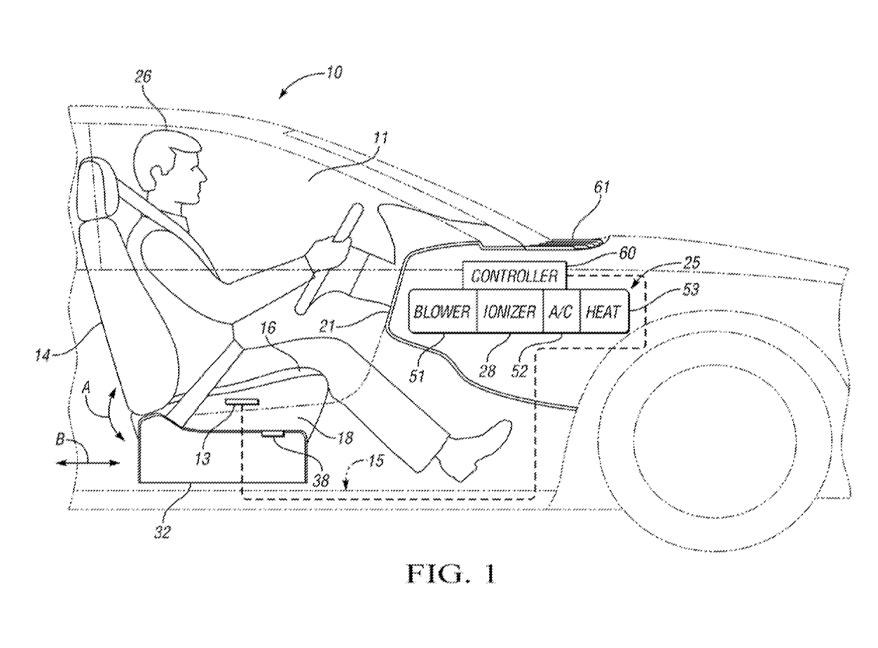

Referring to FIG. 1, wherein like reference numbers correspond to like or similar components throughout the several figures, a vehicle 10 is shown having a vehicle interior or passenger compartment 11. A floor pan or floor 15 spans the passenger compartment 11 and supports a vehicle seat 14 that faces a console or instrument panel 21 and is configured to carry a driver, passenger, or other occupant 26 of vehicle 10. The vehicle seat 14 has a seat cushion 18 with a seating surface 16, i.e., the surface of the vehicle seat 14 having the most direct and sustained contact with the occupant 26, with the vehicle seat 14 being upholstered or covered in an aesthetically pleasing manner, such as with leather or a suitable fabric upholstery (not shown), and mounted or fastened to a suitable seat base or frame 32. The seat 14 is preferably variably repositionable with respect to the floor 15 in response to readily accessible occupant-selectable seat controls 38, such as a power or manual seat height and position adjuster and/or seat recliner mechanism, switch, and/or lever adapted to move or reposition the seat 14 forward and rearward as desired within the passenger compartment 11, as represented by arrows A, as well as recline and incline the seat 14, as represented by arrows B, to thereby adjust for various seat position preferences of different occupants 26.

As an occupant 26 operates or drives the vehicle 10, the separation and movement of electrically charged air and dust particles in close proximity to the outer surfaces of the vehicle 10 may act to impart a static charge to the vehicle 10. Additionally, in exiting or alighting from the vehicle 10, the movement and separation of an occupant 26 relative to the vehicle seat 14 is often sufficient to generate an accumulated charge on the seating surface 16 and/or on the occupant 26. Then, as the occupant 26 touches the vehicle 10 upon exiting, particularly when touching a conductive vehicle component such as a metal door or door handle (not shown), the electrostatic charge carried by the occupant 26 may rapidly discharge or transfer back to the vehicle 10.

Therefore, to help minimize such an electrostatic discharge or ESD event, the vehicle seat 14 is equipped or configured with a sensor 13 suitably configured for detecting the separation of an occupant 26 from the vehicle seat 14, and for communicating this event to a controller 60 to thereby activate or initiate an air ionization device or ionizer 28, as will be described in more detail hereinbelow. The sensor 13 is placed within the seat cushion 18 at or below the seating surface 16, preferably at a depth sufficient to allow proper function of the sensor 13 without adversely affecting the comfort of the vehicle seat 14. Sensor 13 may be a pressure transducer or other suitable pressure-sensitive device configured to detect the relieving or removal of a substantial amount of weight from the vehicle seat 14, such as would occur when an occupant 26 exits the vehicle 10. Alternately, other sensors may be used along with or in place of sensor 13, such as infrared or heat-sensitive sensors (not shown), and/or other types of sensors suitable for detecting the presence of an occupant 26 in the vehicle seat 14.

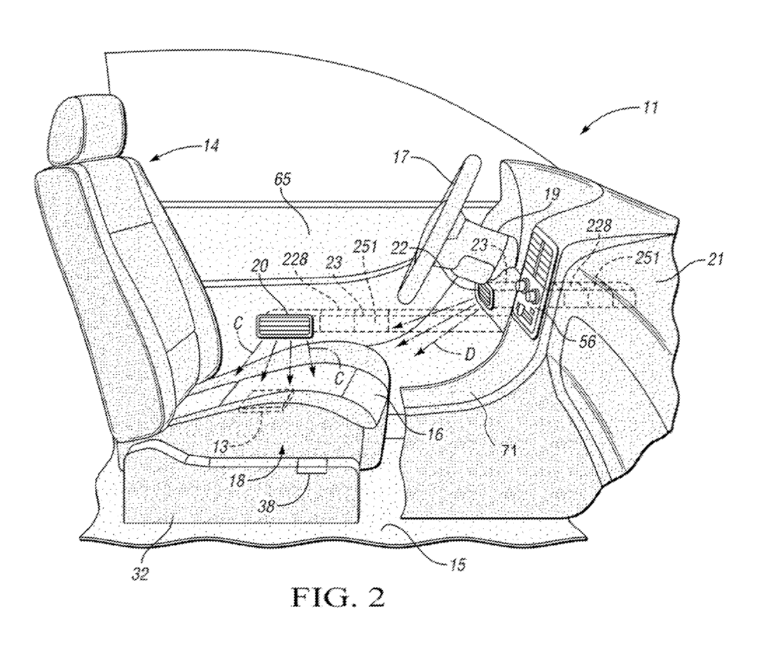

The controller 60 is in electrical communication with sensor 13 and preferably also with a heating, ventilation, and air conditioning (HVAC) system 25. The HVAC system 25 includes an air ionization system or ionizer 28, a fan or blower 51, an air conditioning unit 52, and a heating system or heater 53, with the HVAC system 25 being selectively controllable by an occupant 26 using an HVAC control panel 56 (see FIG. 2) that is centrally or accessibly positioned on the instrument panel 21. The ionizer 28 is operatively attached to or formed integrally with the fan or blower 51, with the blower 51 having a motorized internal fan (not shown) or other similar electromechanical device operable for circulating or moving air drawn through an air intake 61 through the HVAC system 25 and into the passenger compartment 11, as determined by the selected settings on the HVAC control panel 56. Alternately, the ionizer 28 and blower 51 may be separate from the HVAC system 25 to facilitate placement of the ionizer 28 and blower 51 in proximity to the point of use, as will be described in more detail later hereinbelow. The ionizer 28 likewise is preferably activated by the occupant 26 using the HVAC control panel 56 or a separate device (not shown), so that the HVAC system 25 may be operated with or without also operating the ionizer 28, depending on the personal preference of the occupant 26.

As will be understood by those of ordinary skill in the art, ionizer 28, whether integrated with the blower 51 or operating as a separate device, is any mechanism capable of electrically charging air molecules, generally by exposing air to a high voltage. Ionizer 28 may be designed to generate specifically charged ions, i.e. exclusively positively or negatively charged ions, or to randomly or indiscriminately generate a combination of both positive and negative ions as needed, depending on design requirements. Various methods are available to ionize air so that the air may thereby conduct an electric charge. For example, an air stream may be subjected to controlled sparking or arcing, or preferably, air may be ionized by using AC, steady-state DC, or pulse-DC ionization methods.

By ionizing air, the ionizer 28 may provide air molecules with the ability to carry an electrical charge. Air molecules may come from an available air stream, such as provided or generated by HVAC system 25, or alternately from an air stream that is separately generated outside of HVAC system 25. When the charged or ionized air stream is directed toward charged surfaces within the passenger compartment 11, such as the seating surface 16 of the vehicle seat 14 in accordance with the invention, an electrostatic charge resident on and/or between the occupant 26 and seating surface 16 is effectively neutralized. As a result, the effect of any ESD event experienced by an occupant 26 upon exiting the vehicle 10 is minimized.

Turning now to FIG. 2, the passenger compartment 11 is shown in greater detail having a vehicle seat 14 with a seat cushion 18 supported by a frame 32, as described hereinabove. The seat cushion 18 has a seating surface 16, under which is positioned the sensor 13, also as previously described hereinabove. A door 65 is adjacent to the vehicle seat 14, and includes an HVAC opening or vent 20 that is in fluid communication with or otherwise connected to the HVAC system 25 (see FIG. 1), such as through a pipe, duct 23, or other suitable conduit. A console 71 is positioned between two seats, such as vehicle seat 14 and a substantially similar passenger-side seat (not shown) and/or between two rear seats (not shown), and may include, for example, compact disc (CD) holders, coin holders, cupholders, and/or an armrest. As shown, the console 71 is integral with and flows into the instrument panel 21, but may also stand alone as a separate component within the scope of the invention. Although only a portion of console 71 is shown in FIG. 2 so as to more clearly show vehicle seat 14, console 71 preferably also includes a vent 20 (not shown) in the rear of the console 71 facing a rear or back seat (not shown), and connected with HVAC system 25 as described hereinabove, so as to deliver ionized air to a rear passenger seat (not shown).

As shown in phantom, an ionizer 228 and blower 251 may also be positioned within a duct 23 apart from the HVAC system 25 and in proximity to the vent 20, such that the ionizer 228 and blower 251 are operable for generating and/or circulating its own ionized air in response to controller 60 and sensor 13 as described hereinabove, without requiring electrical communication with the HVAC system 25. Additionally, a substantially similar HVAC opening or vent 22 is positioned on or within instrument panel 21, along with an alternate ionizer 228 and blower 251 as previously described hereinabove. The HVAC control panel 56 is preferably positioned within accessible reach of an occupant 26 (see FIG. 1) seated in the vehicle seat 14. While the vehicle seat 14 as shown in FIG. 2 is a driver-side seat positioned facing a steering wheel 17 and steering column 19, any vehicle seat 14 within the passenger compartment 11 may be similarly configured in accordance with the invention, for example a passenger-side seat or rear seat (not shown).

When the ionizer 28 is activated, and upon detection by sensor 13 of the separation of an occupant 26 from the vehicle seat 14, a portion of air from the HVAC system 25 is diverted to the ionizer 28. Alternately, when the ionizer 228 is activated, air is directed to the ionizer 228 by blower 251. A sufficient portion or amount of ionized air, represented by arrows C in FIG. 2, is then directed by vent 20 across the seat cushion surface 16 of the vehicle seat 14. Likewise, ionized air, represented by arrows D, is directed by vent 22 on instrument panel 21 across and/or at seating surface 16, with the vents 20 and 22 preferably being simultaneously operable so as to maximize the concentration of ions dispersed by the vents 20, 22 into proximity with the vehicle seat 14. Alternately, the ionizer 28 may be activated and continuously operable whenever the HVAC system 25 is in operation, while an occupant 26 remains seated and without regard to the operation of sensor 13. However, selective activation of the ionizer 28/228 is preferred, so as to allow an occupant 26 to decide when additional ESD protection is desired, such as during dry weather conditions, while allowing the occupant 26 to turn the ionizer 28/228 off during humid or otherwise low-ESD weather conditions.

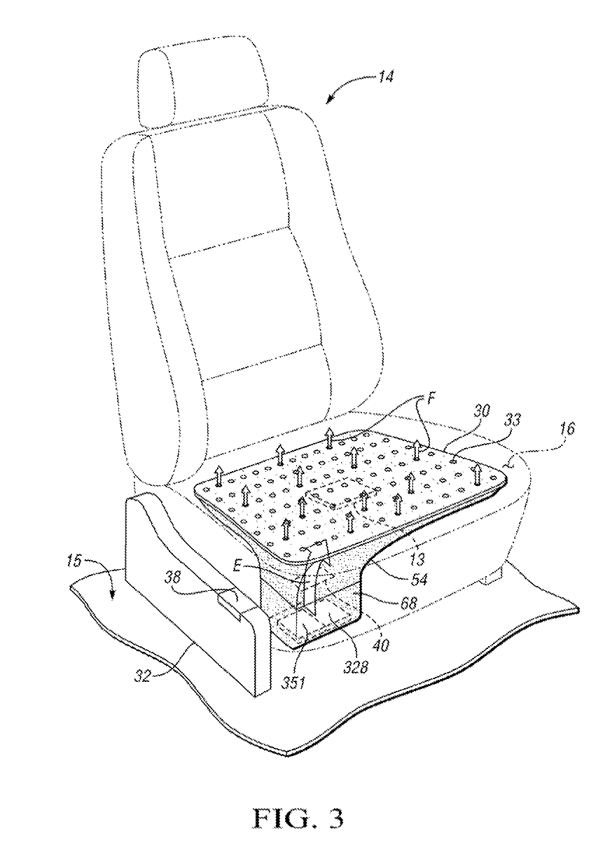

Turning now to FIG. 3, a second embodiment of the invention is shown as a vehicle seat 14 configured with a seat cooling device in which a seat cooling duct 54 delivers cool air, represented by arrow E, from a seat cooling unit 68 positioned at a suitable location within the seat 14, such as under the seat cushion 18. The cool air (arrow E) is preferably generated within the seat cooling unit 68, for example by using an internal fan or blower 351 or other suitable device, and then channeled or routed through an upper opening 40 in the seat cooling unit 68 and through the seat cooling duct 54. An ionizer 328 is likewise positioned within the seat 14 and is operable for generating a supply of ionized air in response to sensor 13, as previously described hereinabove with reference to ionizer 28/228 (see FIG. 1). A seat vent 30 is positioned within the vehicle seat 14 under the seating surface 16, or alternately configured to function as the seating surface 16, and preferably takes the form of a perforated trim insert or other suitable component having a plurality of orifices or holes 33 for dispersing the cool air (arrow E) into numerous, smaller air streams, as represented by the arrows F. Seat cooling unit 68 may be operated in conjunction with ionizer 328 when the ionizer 328 is activated, or alternately may be operated independently of the ionizer 328, with ionized air (arrows F) being delivered to the seating surface 16 when the ionizer 328 is activated by the sensor 13, thereby taking advantage of any existing holes 33 already used in conjunction with a seat cooling system.

While the best modes for carrying out the invention have been described in detail, those familiar with the art to which this invention relates will recognize various alternative designs and embodiments for practicing the invention within the scope of the appended claims.

1. An apparatus for dissipating an electrostatic charge from a seating surface of a vehicle seat and from an occupant seated on the seating surface, the apparatus comprising an ionizer operable for ionizing a supply of air and a blower which directs a sufficient amount of said supply of ionized air toward the seating surface to thereby neutralize the electrostatic charge.

2. The apparatus of claim 1, including a vent positioned external to the vehicle seat, wherein said blower directs said supply of ionized air toward the seating surface through said vent.

3. The apparatus of claim 2, including a heating, ventilating, and air conditioning (HVAC) system, wherein said HVAC system is in fluid communication with said vent.

4. The apparatus of claim 1, including a sensor configured to detect when the occupant is separating from the vehicle seat, wherein said blower directs said supply of ionized air toward the seating surface when said separating is detected by said sensor.

5. The apparatus of claim 1, including a vent positioned within the vehicle seat, wherein said blower is positioned beneath the vehicle seat and directs said supply of ionized air toward the seating surface through said perforated vent.

6. The apparatus of claim 5, including a seat cooling system operable for directing a supply of cool air at the seating surface through said perforated vent, wherein said supply of ionized air is a portion of said supply of cool air.

7. The apparatus of claim 5, wherein said perforated vent is sufficiently positioned to function as the seating surface.

8. A vehicle comprising:
a vehicle seat having a seating surface for carrying an occupant;
a sensor configured to detect when said occupant is separating from said seating surface;
an ionizer operable for generating a supply of ionized air; and
a blower configured to direct a sufficient amount of said supply of ionized air toward said seating surface and said occupant when said separating is detected, said supply of ionized air being sufficient for neutralizing an electrostatic charge on said seating surface and on said occupant and for thereby minimizing an electrostatic discharge occurring between said occupant and said vehicle when said occupant exits said vehicle.

9. The vehicle of claim 8, including a vent positioned external to said vehicle seat, wherein said blower directs said supply of ionized air toward said vehicle seat through said vent.

10. The vehicle of claim 9, wherein said vent is an HVAC vent.

11. The vehicle of claim 8, including a vent positioned within said vehicle seat, wherein said blower is operable for directing said supply of ionized air toward said seating surface through said vent.

12. The vehicle of claim 11, wherein said vehicle seat has a seat cooling system operable for directing a supply of cool air through said seating surface for cooling of said occupant, and further has a vent positioned within said vehicle seat, wherein said supply of ionized air is a portion of said supply of cool air, and wherein said blower is operable for directing said supply of ionized air toward said seating surface and said occupant through said vent.

13. A method of dissipating an electrostatic charge from a surface of a vehicle seat configured to carry an occupant, and from the occupant seated on the vehicle seat, the method comprising:
generating a sufficient supply of ionized air for dissipating the electrostatic charge;
sensing separation of the occupant from the surface; and
directing said supply of ionized air toward the surface and toward the occupant to thereby dissipate the electrostatic charge.

14. The method of claim 13, wherein said directing of said supply of ionized air includes passing said supply of ionized air through at least one vent positioned external to the vehicle seat.

15. The method of claim 13, wherein said directing of said supply of ionized air includes passing said supply of ionized air through a vent positioned within the vehicle seat.

16. The method of claim 13, further comprising equipping said vehicle seat with a seat cooling system having a vent for directing a supply of cool air through the surface of the vehicle seat to thereby cool the occupant, wherein said supply of ionized air is an ionized portion of said supply of cool air.

17. The method of claim 16, including configuring said vent as a perforated insert and positioning said perforated insert beneath the surface of the vehicle seat.
